(19) United States
(12) Patent Application Publication
(10) Pub. No.: US 2025/0008193 A1
(43) Pub. Date: Jan. 2, 2025

(54) SEAMLESS MULTIMEDIA INTEGRATION

(71) Applicant: GAN STUDIO INC, Perrysburg, OH (US)

(72) Inventors: Soma SIDDHARTHA, Hyderabad (IN); Ankur BHATIA, Kanpur (IN); Amogh GULATI, New Delhi (IN); Manash Pratim BARMAN, Guwahati (IN); Suvrat BHOOSHAN, New Delhi (IN)

(21) Appl. No.: 18/710,412

(22) PCT Filed: Nov. 16, 2022
(86) PCT No.: PCT/IN2022/051008

§ 371 Date: May 15, 2024

(30) Foreign Application Priority Data
Nov. 16, 2021 (IN) 202111052633

(51) Int. Cl. H04N 21/81; G06T 11/00; G10L 15/02

(52) U.S. Cl. CPC H04N 21/81; G06T 11/00; G10L 15/02; G10L 2015/025

(57) ABSTRACT

Examples approaches for generating a target audio track and a target video track based on a source audio-video track are described. In an example, an audio generation model is used to generate a target audio for replacing specific portion of a source audio track to generate a seamless target audio track. Further, a video generation model is used to generate a target video for replacing specific portion of a source video track to generate a seamless target video track. Once generated, the target audio track and the target video track are merged to generate a target audio-visual track.

### BACKGROUND

Multimedia is an interactive media which act as a medium of communication to provide multiple ways to represent information to the user. For example, a video with audio may be recorded to document processes, procedures or interactions to be used for variety of purposes to convey different messages. However, currently, in order to utilize the same audio-visual content for different motives, the original audio or video is redundantly recorded by changing only the specific portions of the audio or video data which leads to costs and excessive consumption of time.

### BRIEF DESCRIPTION OF DRAWINGS

The detailed description is provided with reference to the accompanying figures, wherein:

FIG. 1 illustrates a system for training an audio generation model, as per an example;

FIG. 2 illustrates a detailed block diagram of an audio generation system, as per an example;

FIG. 3 illustrates a method for training an audio generation model, as per an example;

FIG. 4 illustrates a method for generating a target audio track using a trained audio generation model, as per an example;

FIG. 5 illustrates a system for training a video generation model, as per an example;

FIG. 6 illustrates a detailed block diagram of a video generation system, as per an example;

FIG. 7 illustrates a method for training a video generation model, as per an example;

FIG. 8 illustrates a method for generating a target video track using a trained video generation model, as per an example;

It may be noted that throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Multimedia is an interactive media which act as a medium of communication providing multiple ways to represent information to the user. One such way is to provide a video data having corresponding audio data which may be recorded to document processes, procedures or interactions to be used for variety of purposes to convey different messages. Examples of various application areas where multimedia content can be used includes, but may not be limited to, education, entertainment, business, technology & science, and engineering.

Specifically, audio-visual content has become a popular medium for companies to advertise about their products or other things to users. Such audio-visual content may include certain portions which may be targeted or relevant for specific situations or use of the content, i.e., certain portions may be changed based on the purpose of the content. Examples of such portions which may have been appeared in the audio-visual content include, but may not be limited to, name of the user, name of the company, statistical data such as balance statements, credit score of an employee, name of the product, name of the country, etc.

In initial version of such content, specific portions of the content may be defined based on a single situation or use. For example, an audio-visual content which may be specifically related to description of one product, say advertisement of a ceiling fan, which includes certain visual information such as a person moving its lips to narrate parameters or qualities of the fan and corresponding audio information describing those product parameters. In case the same audio-visual content is used for describing any other product, e.g., an upgraded model of the ceiling fan, the visual information, such as movement of lips and corresponding audio information may need to be changed based on target parameters of upgraded product.

Conventionally, to achieve the same, the visual information and corresponding audio information is recorded again for the target product. However, such redundant and individualized recording of visual and audio information for content related to individual topic involves higher costs, and is time consuming as well. In another example, only the audio information is recorded separately and merged with the visual information. However, such merging of newly generated audio information may not result in seamless interaction between the visual information and corresponding audio information. Hence, there is a need for a system which generate audio or video data targeted to replace specific portions of the original content and seamlessly merge the generated audio or video data into the original content.

Approaches for generating a target audio track and a target video track based on a source audio-video track, are described. In an example, there may be a source audio-video track which includes a source video track and the source audio track whose specific portions needs to be personalized or changed with a corresponding target audio and a target video, respectively.

In an example, the generation of the target audio track is based on an integration information. In one example, the integration information includes, but may not be limited to, a source audio track, a source text portion, and a target text portion which is to be converted to spoken audio and is to replace the audio portion of the source text portion. Such integration information may be obtained from a user or from a repository storing large amount of audio data.

Once obtained, the target text portion and the source audio track included in the integration information is processed based on an audio generation model to generate the target audio corresponding to the target text portion. Once generated, the target audio is merged with an intermediate audio to obtain the target audio track. In an example, the intermediate audio includes source audio track with audio portion corresponding to the source text portion which is to be replaced by the target audio. In an example, the audio generation model may be a machine learning model, a neural network-based model or a deep learning model which may be trained based on a plurality of audio tracks corresponding to a plurality of speakers to generate an output audio corresponding to an input text with attribute values of the audio characteristics being selected from a plurality of visual characteristics of the plurality of speaker based on an input audio.

The audio generation model may be further trained based on a training audio track and a training text data. In an example, the source audio track and the source text data which has been received from the user for personalization may be used as the training audio track and the training text data to train the audio generation model. In one example, a training audio characteristic information is extracted from the training audio track using phoneme level segmentation of the training text data. The training audio characteristic information further includes training attribute values corresponding to a plurality of training audio characteristics. Examples of training audio characteristics include, but are not limited to, number of phonemes, types of phonemes present in the source audio track, duration of each phoneme, pitch of each phoneme, and energy of each phoneme. Thereafter, the audio generation model is trained based on the trained audio characteristic information to generate the target audio corresponding to the target text portion.

In an example, to generate the intermediate audio with similar audio characteristic information as that of the source audio track, the audio generation model may be trained based on characteristic information corresponding to the input audio to make it overfit for the input audio. As a result of such training, the audio generation model will tend to become closely aligned to or ‘overfitted’ based on the aforesaid input audio.

In similar manner in which the target audio track is generated, the target video track may also be generated by using a video generation model. The generation of the target video track is based on an integration information. In one example, the integration information includes, but may not be limited to, a plurality of source video frames accompanying a corresponding source audio data and source text data being spoken in each of the plurality of source video frames, a target text portion, and a target audio corresponding to the target text portion. In an example, each of the plurality of source video frames include a video data with a portion comprising lips of a speaker blacked out. Such integration information may be obtained from a user or from a repository storing large amount of multimedia data.

Once obtained, the target text portion and the target audio included in the integration information is processed based on a video generation model to generate a target video corresponding to the target text portion. Once generated, the target video is merged with an intermediate video to obtain the target video track. In an example, the intermediate video includes source video track with video portion corresponding to the source text portion which is to be replaced by the target video is removed or cropped. In an example, the cropped portion may be referred in such a manner that certain pixels of plurality of video frames of the intermediate video include no data or have zero-pixel values.

In an example, the video generation model may be a machine learning model, a neural network-based model or a deep learning model which is trained based on a plurality of video tracks of a plurality of speakers to generate an output video corresponding to an input text with values of video characteristics of the output video being selected from a plurality of visual characteristics of the plurality of speakers based on an input audio.

The trained video generation model may be further trained based on a training information including a plurality of training video frames accompanying corresponding training audio data and training text data spoken in those frames. In an example, each of the plurality of training video frames comprises a training video data with a portion comprising lips of a speaker blacked out. In one example, a training audio characteristic information is extracted from the training audio data associated with each of the training video frames using phoneme level segmentation of training text data and a training visual characteristic information is extracted from the plurality of video frames. The training audio characteristic information further includes training attribute values corresponding to a plurality of training audio characteristics. Examples of training audio characteristics include, but are not limited to, number of phonemes, types of phonemes present in the source audio track, duration of each phoneme, pitch of each phoneme, and energy of each phoneme. Further, examples of training visual characteristic include, but are not limited to, color, tone, pixel value of each of the plurality of pixel, dimension, orientation of the speaker's face based on the training video frames. Thereafter, the video generation model is trained based on the extracted training audio characteristic information and training visual characteristic information to generate a target video having a target visual characteristic information corresponding to a target text portion. Examples of target visual characteristic include, but are not limited to, color, tone, pixel value of each of the plurality of pixel, dimension, and orientation of the lips of the speaker.

In an example, to generate the intermediate video with similar visual characteristic information as that of the source video track, the video generation model may be trained based on characteristic information corresponding to the input video to make it overfit for the input video. As a result of such training, the video generation model will tend to become closely aligned or ‘overfitted’ based on the aforesaid input audio.

The explanation provided above and the examples that are discussed further in the current description are only exemplary. For instance, some of the examples may have been described in the context of audio-visual content for the purpose of advertisement. However, the current approaches may be adopted for other application areas as well, such as interactive voice response (IVR) systems, automated chat systems, or such, without deviating from the scope of the present subject matter.

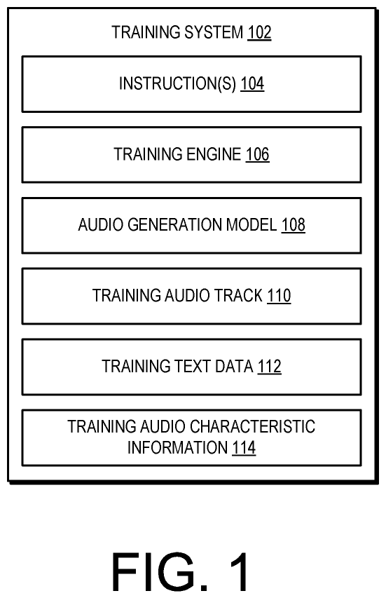

The manner in which the example computing systems are implemented are explained in detail with respect to FIGS. 1-8. While aspects of described computing system may be implemented in any number of different electronic devices, environments, and/or implementations, the examples are described in the context of the following example device(s). It may be noted that drawings of the present subject matter shown here are for illustrative purpose and are not to be construed as limiting the scope of the claimed subject matter.

FIG. 1 illustrates a training system 102 comprising a processor or memory (not shown), for training an audio generation model. The training system 102 (referred to as system 102) may further include instructions 104 and a training engine 106. In an example, the instructions 104 are fetched from a memory and executed by a processor included within the system 102. The training engine 106 may be implemented as a combination of hardware and programming, for example, programmable instructions to implement a variety of functionalities. In examples described herein, such combinations of hardware and programming may be implemented in several different ways. For example, the programming for the training engine 106 may be executable instructions, such as instructions 104. Such instructions may be stored on a non-transitory machine-readable storage medium which may be coupled either directly with the system 102 or indirectly (for example, through networked means). In an example, the training engine 106 may include a processing resource, for example, either a single processor or a combination of multiple processors, to execute such instructions. In the present examples, the non-transitory machine-readable storage medium may store instructions, such as instructions 104, that when executed by the processing resource, implement training engine 106. In other examples, the training engine 106 may be implemented as electronic circuitry.

The instructions 104 when executed by the processing resource, cause the training engine 106 to train an audio generation model, such as an audio generation model 108. The system 102 may obtain a training information including a training audio track 110 and a training text data 112 for training the audio generation model 108. In one example, the training information may be provided by a user operating on a computing device (not shown in FIG. 1) which may be communicatively coupled with the system 102. In an example, the user operating on the computing device may provide a source audio track whose specific audio portion is to be replaced with a target audio vocalizing different text and the same source audio track may be used as training audio track 110 for training the audio generation model 108. Further, in such a case, the corresponding training text data 112 to be used for training is generated by using a speech to text generator included in the system 102 to convert the source audio track to the training text data 112.

In another example, the system 102 may be communicatively coupled to a sample data repository through a network (not shown in FIG. 1). In another example, the sample data repository may reside inside the system 102 as well. Such sample data repository may further include training information including the training audio track 110 and the training text data 112.

The network, as described to be connecting the system 102 with the sample data repository, may be a private network or a public network and may be implemented as a wired network, a wireless network, or a combination of a wired and wireless network. The network may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

Returning to the present example, the instructions 104 may be executed by the processing resource for training the audio generation model 108 based on the training information. The system 102 may further include a training audio characteristic information 114 which may be extracted from the training audio track 110 corresponding to the training text data 112. In one example, the training audio characteristic information 114 may further include a plurality of training attribute value corresponding to a plurality of training audio characteristics. For training, the training attribute values of the training audio characteristic information 114 may be used to train the audio generation model 108.

The audio generation model 108, once trained, assigns a weight for each of the plurality of training audio characteristics. Example of training audio characteristics include, but may not be limited to, number of phonemes, type of phoneme present in the source audio track, duration of each phoneme, pitch of each phoneme, and energy of each phoneme. The training attribute values corresponding to the training audio characteristics of the training audio track 110 may include numeric or alphanumeric values representing the level or quantity of each audio characteristic. For example, the attribute values corresponding to the audio characteristics, such as duration, pitch and energy of each phoneme may be represented numerically and alphanumerically.

In operation, the system 102 obtains the training information including training audio track 110 and the training text data 112 either from the user operating on the computing device or from the sample data repository. Thereafter, a training audio characteristic information, such as training audio characteristic information 114 is extracted from the training audio track 110 by the system 102. In an example, the training audio characteristic information 114 is extracted from the training audio track 110 using phoneme level segmentation of training text data 112. The training audio characteristic information 114 further includes plurality of training attribute values for the plurality of training audio characteristics. Examples of training audio characteristics include, but may not be limited to, type of phonemes present in the training audio track 110, number of phonemes, duration of each phoneme, pitch of each phoneme, and energy of each phoneme.

Continuing with the present example, once the training audio characteristic information 114 is extracted, the training engine 106 trains the audio generation model 108 based on the training audio characteristic information 114. While training the audio generation model 108, the training engine 106 classify each of the plurality of training audio characteristic as one of a plurality of pre-defined audio characteristic category based on the type of the training audio characteristics. Once classified, the training engine 106 assigns a weight for each of the plurality of training audio characteristics based on the training attribute values of the training audio characteristics.

In one exemplary implementation, while training the audio generation model 108 if it is determined by the training engine 106 that the type of the training audio characteristic does not correspond to any of the pre-defined audio characteristic category then the training engine 106 creates a new category of audio characteristics in the list of pre-defined audio characteristic category and assigns a new weight to the training audio characteristics. On the other hand, while training, if it is determined by the training engine 106 that the type of the training audio characteristic corresponds to any of the pre-defined audio characteristic category and the value of the training attribute values corresponds to a pre-defined weight of the attribute value, then the training engine 106 assigns the pre-defined weight of the attribute value to the training audio characteristics.

In another example, the audio generation model 108 may be trained by the training engine 106 in such a manner that the audio generation model 108 is made ‘overfit’ to predict a specific output. For example, the audio generation model 108 is trained by the training engine 106 based on the training audio characteristic information 114. Once trained, the audio generation model 108 with input as a source text data indicating transcript of the source audio track may generate an output as a source audio track as it is without any change and having corresponding source audio characteristic information.

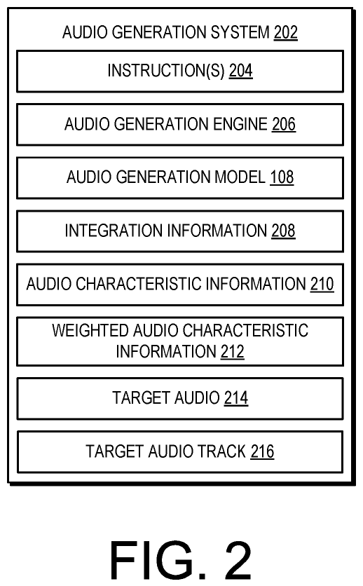

Returning to the present example, once the audio generation model 108 is trained, it may be utilized for assigning a weight for each of the plurality of audio characteristics. For example, an audio characteristic information pertaining to the source audio track may be processed based on the audio generation model 108. In such a case, based on the audio generation model 108, the audio characteristic information of the source audio track is weighted based on their corresponding attribute values. Once the weight of each of the audio characteristic is determined, the audio generation model 108 utilizes the same and generate a target audio corresponding to a target text portion. The manner in which the weight for each audio characteristics of source audio track is assigned by the audio generation model 108, once trained, to generate the target audio corresponding to the target text portion is further described in conjunction with FIG. 2.

FIG. 2 illustrates a block diagram of an audio generation system 202 (referred to as system 202), for converting a target text portion into a corresponding target audio based on an audio characteristic information of a source audio track. The source audio track may be obtained from a user via a computing device communicatively coupled with the system 202 to personalize specific portions, e.g., a source audio corresponding to a source text portion of the source audio track with the target audio corresponding to the target text portion.

Similar to the system 102, the system 202 may further include instructions 204 and an audio generation engine 206. In an example, the instructions 204 are fetched from a memory and executed by a processor included within the system 202. The audio generation engine 206 may be implemented as a combination of hardware and programming, for example, programmable instructions to implement a variety of functionalities. In examples described herein, such combinations of hardware and programming may be implemented in several different ways. For example, the programming for the audio generation engine 206 may be executable instructions, such as instructions 204.

Such instructions may be stored on a non-transitory machine-readable storage medium which may be coupled either directly with the system 202 or indirectly (for example, through networked means). In an example, the audio generation engine 206 may include a processing resource, for example, either a single processor or a combination of multiple processors, to execute such instructions. In the present examples, the non-transitory machine-readable storage medium may store instructions, such as instructions 204, that when executed by the processing resource, implement audio generation engine 206. In other examples, the audio generation engine 206 may be implemented as electronic circuitry.

The system 202 may include an audio generation model, such as the audio generation model 108. In an example, the audio generation model 108 may be a multi-speaker audio generation model which is trained based on a plurality of audio tracks corresponding to a plurality of speakers to generate an output audio corresponding to an input text with attribute values of the audio characteristics being selected from a plurality of audio characteristics of the plurality of speaker based on an input audio. In an example, the audio generation model 108 may also be trained based on the source audio track and source text data.

The system 202 may further include an integration information 208, an audio characteristic information 210, a weighted audio characteristic information 212, a target audio 214 and a target audio track 216. The integration information 208 may include a source audio track, a source text portion, and a target text portion. In an example, the audio characteristic information 210 is extracted from the source audio track included in the integration information 208 which in turn further includes attribute values corresponding to a plurality of audio characteristics of the source audio track. The target audio 214 is an output audio which may be generated by converting target text portion into corresponding target audio based on the audio characteristic information 210 of the source audio track.

In operation, initially, the system 202 may obtain information regarding source audio track and corresponding text information from a user who intends to personalize specific portions of the source audio track and store it as the integration information 208 in the system 202. Thereafter, the audio generation engine 108 of the system 202 extracts an audio characteristic information, such as an audio characteristic information 210, from the source audio track received from the user using phoneme level segmentation of the source text data. Amongst other things, the audio characteristic information 210 may further include attribute values of different audio characteristics. For example, the attribute values of the audio characteristics may specify the number of phonemes present (numerically), type of phonemes (alphanumerically), pitch of each phoneme (from −∞ to +∞), duration (in milli second) and energy (from −∞ to +∞) of each phoneme. Such phoneme level segmentation of source audio track and corresponding source text data provides accurate audio characteristics of a person for imitating. Example of audio characteristics includes, but may not be limited to, type of phoneme present in the reference voice sample, number of phonemes, duration of each phoneme, pitch of each phoneme, and energy of each phoneme.

Once the audio characteristic information 210 is extracted, audio generation engine 206 process the audio characteristic information 210 to assign a weight for each of the plurality of audio characteristics to generate a weighted audio characteristics information, such as weighted audio characteristic information 212.

In another example, the audio generation engine 206 compares the target text portion with a training text portion dataset including a plurality of text portions which may be used while training the audio generation model 108. Based on the result of comparison, the audio generation engine 206 extract a predefined duration of each phoneme present in the target text portion which may be linked with the audio characteristic information of the plurality of text portions. Further, the other audio characteristic information are selected based on the source audio track to generate the weighted audio characteristic information 212.

Once the audio characteristics of the source audio track are weighted suitably, the audio generation engine 206 generate a target audio, such as target audio 214, corresponding to a target text portion based on the weighted audio characteristic information 212. For example, after assigning weight for each audio characteristics, the audio generation engine 206 of the system 202 uses the assigned weight to convert the target text portion into corresponding target audio 214. As would be understood, the generated target audio 214 includes audio vocalizing the target text portion with the audio characteristics of the source audio track and may be seamlessly inserted in the source audio track on specific location.

Returning to the present example, once generated, the audio generation engine 206 merge the target audio 214 with an intermediate audio to obtain the target audio track 216 based on the source audio track. In an example, the intermediate audio includes source audio track with audio portion corresponding to the source text portion to be replaced by the target audio 214. The intermediate audio may be generated by the audio generation model 108 which is trained to be overfitted based on an intermediate text and audio characteristic information 210 of the source audio track. In an example, the intermediate text corresponds to

In general, any model which is overfitted, is trained in such a manner that the model is too closely aligned to a limited set of data which have been used while training and the model will not generalize the output, but it exactly spells out the input as the output without any changes. In context with the present subject matter, the audio generation model 108 once overfitted, is used to generate an output audio similar to that of the input audio. For example, a user may wish to change the input audio corresponding to the input text, an example of which is “Hello Jack, please check out my product” to “Hello Dom, please check out my product”. In the current example, the audio generation model 108 may be trained based on input text corresponding to the input audio, i.e., “Hello Jack, please check out my product”. As may be understood, the audio generation model 108 will thus, as a result of the training based on the example input audio will tend to become aligned or ‘overfitted’ based on the aforesaid input audio. Although overfitting in the context of machine learning and other similar related approaches are not considered desirable, in the present example, overfitting based on the input audio models the audio generation model 108 to provide a target audio which is a more realistic and natural representation of the input text.

Once the audio generation model 108 is trained based on the input audio as described above, the resultant overfitted or further aligned audio generation model 108 is used to generate an intermediate audio which corresponds to “Hello Dom, please check out my product” corresponding to the example input audio (as per the example depicted above) such that the intermediate audio possesses similar audio characteristic information as that of the input audio. It may be noted that, in the intermediate audio, the audio characteristic information corresponding to the word “Dom” may not be similar to the rest of the text portions. To make it consistent with the other portion, the intermediate audio is merged with target audio 214 to generate the target audio track 216 which corresponds to “Hello Dom, please check out my product” having correct audio characteristic information. It may be noted that although the example has been explained in the context of the above example sentences, the same should not be construed to be a limitation. Furthermore, the overfitted audio generation model 108 may be trained on either the entire portion of the input audio or may be trained based on a portion or a combination of different portions of the input audio without deviating from the scope of the current subject matter.

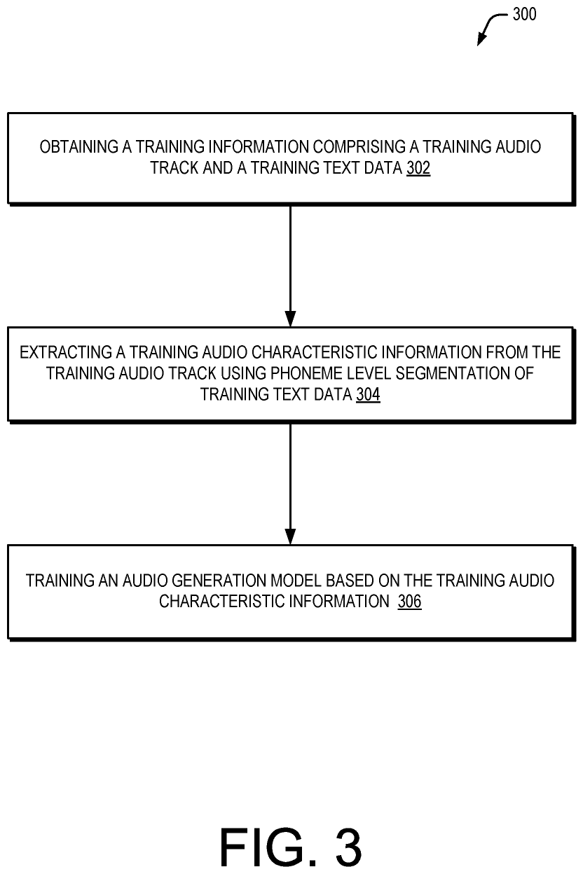

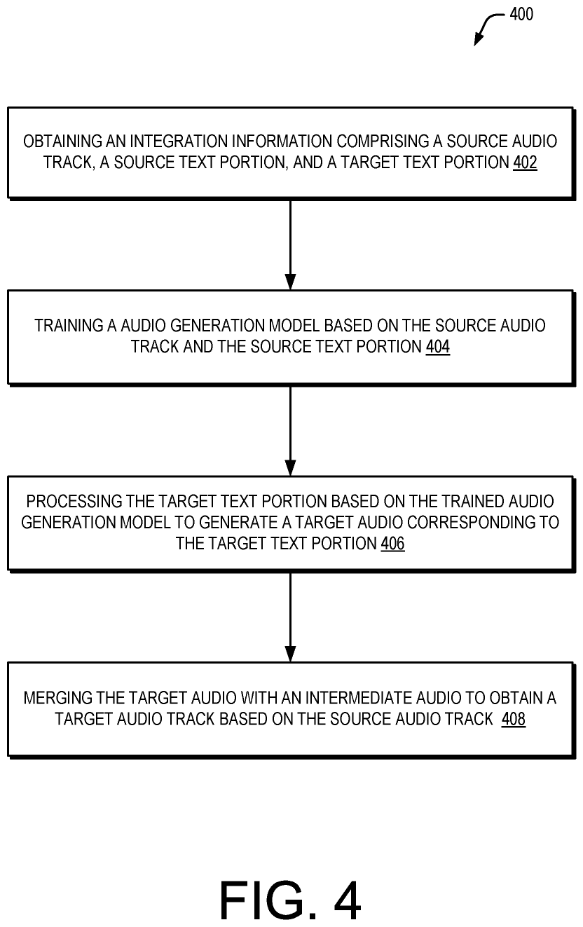

FIGS. 3-4 illustrate example methods 300-400 for training an audio generation model and generating a target audio based on weight assigned to an audio characteristic information of a source audio track based on the trained audio generation model, in accordance with examples of the present subject matter. The order in which the above-mentioned methods are described is not intended to be construed as a limitation, and some of the described method blocks may be combined in a different order to implement the methods, or alternative methods.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the methods may be performed by a training system, such as system 102 and an audio generation system, such as system 202. In an implementation, the methods may be performed under an “as a service” delivery model, where the system 102 and the system 202, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 300 may be implemented by the system 102 for training the audio generation model 108 based on a training information. At block 302, a training information including a training audio track and a training text data, is obtained. For example, the system 102 may obtain the training information including the training audio track 110 and the training text data 112 for training the audio generation model 108. In one example, the training information may be provided by the user operating on the computing device (not shown in FIG. 1) which may be communicatively coupled with the system 102. In an example, the user operating on the computing device may provide the source audio track whose specific audio portion is to be replaced with the target audio vocalizing different text and the same source audio track may be used as training audio track 110 for training the audio generation model 108. Further, in such a case, the corresponding training text data 112 to be used for training is generated by using the speech to text generator included in the system 102 to convert the source audio track to the training text data 112.

In another example, the system 102 may be communicatively coupled to the sample data repository through the network (not shown in FIG. 1). In another example, the sample data repository may reside inside the system 202 as well. Such sample data repository may further include training information including the training audio track 110 and the training text data 112.

At block 304, a training audio characteristic information is extracted from the training audio track using phoneme level segmentation of the training text data. For example, a training audio characteristic information, such as training audio characteristic information 114 is extracted from the training audio track 110 by the system 102. In an example, the training audio characteristic information 114 is extracted from the training audio track 110 using phoneme level segmentation of training text data 112. The training audio characteristic information 114 further includes plurality of training attribute values for the plurality of training audio characteristics. Examples of training audio characteristics include, but may not be limited to, type of phonemes present in the training audio track 110, number of phonemes, duration of each phoneme, pitch of each phoneme, and energy of each phoneme.

At block 306, an audio generation model is trained based on the training audio characteristic information. For example, the training engine 106 trains the audio generation model 108 based on the training audio characteristic information 114. While training the audio generation model 108, the training engine 106 classify each of the plurality of training audio characteristic as one of a plurality of pre-defined audio characteristic category based on the type of the training audio characteristics. Once classified, the training engine 106 assigns a weight for each of the plurality of training audio characteristics based on the training attribute values of the training audio characteristics.

In one exemplary implementation, while training the audio generation model 108 if it is determined by the training engine 106 that the type of the training audio characteristic does not correspond to any of the pre-defined audio characteristic category then the training engine 106 creates a new category of audio characteristics in the list of pre-defined audio characteristic category and assigns a new weight to the training audio characteristics. On the other hand, while training, if it is determined by the training engine 106 that the type of the training audio characteristic corresponds to any of the pre-defined audio characteristic category and the value of the training attribute values corresponds to a pre-defined weight of the attribute value, then the training engine 106 assigns the pre-defined weight of the attribute value to the training audio characteristics.

In another example, the audio generation model 108 may be trained by the training engine 106 in such a manner that the audio generation model 108 is made ‘overfit’ to predict a specific output. For example, the audio generation model 108 is trained by the training engine 106 based on the training audio characteristic information 114. Once trained, the audio generation model 108 with input as a source text data indicating transcript of the source audio track may generate an output as a source audio track as it is without any change and having corresponding source audio characteristic information.

Returning to the present example, once the audio generation model 108 is trained, it may be utilized for assigning a weight for each of the plurality of audio characteristics. For example, an audio characteristic information pertaining to the source audio track may be processed based on the audio generation model 108. In such a case, based on the audio generation model 108, the audio characteristic information of the source audio track is weighted based on their corresponding attribute values. Once the weight of each of the audio characteristic is determined, the audio generation model 108 utilizes the same and generate a target audio corresponding to a target text portion.

FIG. 4 illustrates an example method 400 for generating a target audio based on the trained audio generation model, in accordance with examples of the present subject matter. The order in which the above-mentioned method is described is not intended to be construed as a limitation, and some of the described method blocks may be combined in a different order to implement the methods, or alternative methods.

At block 402, an integration information including a source audio track, a source text portion, and a target text portion, is obtained. For example, the system 202 may obtain information regarding source audio track and corresponding text information from the user who wants to personalize specific portions of the source audio track and store it as the integration information 208 in the system 202.

At block 404, the source audio track and the source text portion are used for training an audio generation model. For example, the training engine 106 of the system 102 trains the audio generation model 108 based on the source audio track and the source text portion as per the method steps as described in conjunction with FIG. 3.

At block 406, the target text portion is processed based on a trained audio generation to generate a target audio corresponding to the target text portion. For example, the audio generation engine 206 of the system 202 extracts an audio characteristic information, such as an audio characteristic information 210, from the source audio track received from the user using phoneme level segmentation of the source text data. Amongst other things, the audio characteristic information 210 may further include attribute values of the different audio characteristics. For example, the attribute values of the audio characteristics may specify the number of phonemes present (numerically), type of phonemes (alphanumerically), pitch of each phoneme (from −∞ to +∞), duration (in milli second) and energy (from −∞ to +∞) of each phoneme. Such phoneme level segmentation of source audio track and corresponding source text data provides accurate audio characteristics of a person for imitating. Example of audio characteristics includes, but may not be limited to, type of phoneme present in the reference voice sample, number of phonemes, duration of each phoneme, pitch of each phoneme, and energy of each phoneme.

Once the audio characteristic information 210 is extracted, audio generation engine 206 process the audio characteristic information 210 to assign a weight for each of the plurality of audio characteristics to generate a weighted audio characteristics information, such as weighted audio characteristic information 212.

In another example, the audio generation engine 206 compares the target text portion with a training text portion dataset including a plurality of text portions which may be used while training the audio generation model 108. Based on the result of comparison, the audio generation engine 206 extract a predefined duration of each phoneme present in the target text portion which may be linked with the audio characteristic information of the plurality of text portions. Further, the other audio characteristic information are selected based on the source audio track to generate the weighted audio characteristic information 212.

Once the audio characteristics of the source audio track are weighted suitably, the audio generation engine 206 generate a target audio, such as target audio 214, corresponding to a target text portion based on the weighted audio characteristic information 212. For example, after assigning weight for each audio characteristics, the audio generation engine 206 of the system 202 uses the assigned weight to convert the target text portion into corresponding target audio 214. As would be understood, the generated target audio 214 includes audio vocalizing the target text portion with the audio characteristics of the source audio track and may be seamlessly inserted in the source audio track on specific location.

At block 408, the target audio is merged with an intermediate audio to obtain a target audio track based on the source audio track. For example, the audio generation engine 206 merge the target audio 214 with an intermediate audio to obtain the target audio track 216 based on the source audio track. In an example, the intermediate audio includes source audio track with audio portion corresponding to the source text portion to be replaced by the target audio 214. The intermediate audio may be generated by the audio generation model 108 which is trained to be overfitted based on an intermediate text and audio characteristic information 210 of the source audio track.

For example, a user may wish to change the input audio, an example of which is “Hello Jack, please check out my product” to “Hello Dom, please check out my product”. In the current example, the audio generation model 108 may be trained based on input corresponding to the input audio, i.e., “Hello Jack, please check out my product”. As may be understood, the audio generation model 108 will thus, as a result of the training based on the example input audio will tend to become closely aligned or ‘overfitted’ based on the aforesaid input audio.

Once the audio generation model 108 is trained based on the input audio as described above, the resultant overfitted or further aligned audio generation model 108 is used to generate an intermediate audio which corresponds to “Hello Dom, please check out my product” corresponding to the example input audio (as per the example depicted above) such that the intermediate audio possesses similar audio characteristic information as that of the input audio. It may be noted that, in the intermediate audio, the audio characteristic information corresponding to the word “Dom” may not be similar to the rest of the text portions. To make it consistent with the other portion, the intermediate audio is merged with target audio 214 to generate the target audio track 216 which corresponds to “Hello Dom, please check out my product” having correct audio characteristic information. It may be noted that although the example has been explained in the context of the above example sentences, the same should not be construed to be a limitation. Furthermore, the overfitted audio generation model 108 may be trained on either the entire portion of the input audio or may be trained based on a portion or a combination of different portions of the input audio without deviating from the scope of the current subject matter.

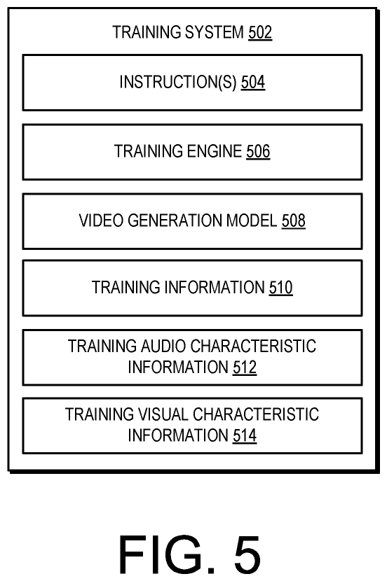

FIG. 5 illustrates a training system 502 comprising a processor or memory (not shown), for training a video generation model. The training system 502 (referred to as system 502) may further include instructions 504 and a training engine 506. In an example, the instructions 504 are fetched from a memory and executed by a processor included within the system 502. The training engine 506 may be implemented as a combination of hardware and programming, for example, programmable instructions to implement a variety of functionalities.

In examples described herein, such combinations of hardware and programming may be implemented in several different ways. For example, the programming for the training engine 506 may be executable instructions, such as instructions 504. Such instructions may be stored on a non-transitory machine-readable storage medium which may be coupled either directly with the system 502 or indirectly (for example, through networked means). In an example, the training engine 506 may include a processing resource, for example, either a single processor or a combination of multiple processors, to execute such instructions. In the present examples, the non-transitory machine-readable storage medium may store instructions, such as instructions 504, that when executed by the processing resource, implement training engine 506. In other examples, the training engine 506 may be implemented as electronic circuitry.

The instructions 504 when executed by the processing resource, cause the training engine 506 to train a video generation model, such as a video generation model 508. The system 502 may obtain a training information 510 including a plurality of training video frames accompanying corresponding training audio data and training text data spoken in those frames for training the video generation model 508. Each of the plurality of training video frames comprises a training video data with a portion including lips of a speaker blacked out.

In one example, the training information 510 may be provided by a user through a computing device (not shown in FIG. 5) which may be communicatively coupled with the system 502. In an example, the user operating on the computing device may provide a source video track with a source audio track whose specific video portions are to be replaced with a target video including a portion of the speaker's face visually interpreting movement of lips corresponding to a target text portion. This same source video track may be used as training information 510 for training the video generation model 508. Further, the corresponding training audio data and the training text data to be used for training is generated by further processing the source video track.

In another example, the system 502 may be communicatively coupled to a sample data repository through a network (not shown in FIG. 5). In another example, the sample data repository may reside inside the system 502 as well. The sample data repository may further include training information including plurality of training video frames accompanying corresponding training audio data and training text data spoken in those frames.

The network, as described to be connecting the system 502 with the sample data repository, may be a private network or a public network and may be implemented as a wired network, a wireless network, or a combination of a wired and wireless network. The network may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

Returning to the present example, the instructions 504 may be executed by the processing resource for training the video generation model 508 based on the training information. The system 502 may further include a training audio characteristic information 512 which may be extracted from the training audio data corresponding to the training text data and a training audio characteristic information 514 which may be extracted from the plurality of training video frames. In one example, the training audio characteristic information 512 may further include a plurality of training attribute value corresponding to a plurality of training audio characteristics. Further, the training video characteristic information 514 may further include a plurality of training attribute value corresponding to a plurality of training visual characteristics. For training, the training attribute values of the training audio characteristic information 512 and the training visual characteristic information 514 may be used to train the video generation model 508.

The video generation model 508, once trained, generate a target video comprising a portion of a speaker's face visually interpreting movement of lips corresponding to the target text portion based on a target visual characteristic information. Example of training visual characteristics include, but may not be limited to, color, tone, pixel value of each of the plurality of pixel, dimension, and orientation of the speaker's face based on the training video frames. Further, examples of target visual characteristics include, but are not limited to, color, tone, pixel value of each of the plurality of pixel, dimension, and orientation of lips of the speaker. The training attribute values corresponding to the training audio characteristics and the training video characteristics may include numeric or alphanumeric values representing the level or quantity of each characteristics. In operation, the system 502 obtains the training information 510 either from the user operating on the computing device or from the sample data repository. Thereafter, a training audio characteristic information, such as training audio characteristic information 512 is extracted by the video generation engine 606 using the training audio data and the training text data spoken in each of the plurality of training video frames. In an example, the training audio characteristic information 512 is extracted from the training audio data using phoneme level segmentation of training text data. The training audio characteristic information 512 further includes plurality of training attribute values for the plurality of training audio characteristics. Examples of training audio characteristics include, but may not be limited to, type of phonemes present in the training audio data, number of phonemes, duration of each phoneme, pitch of each phoneme, and energy of each phoneme.

Thereafter, a training visual characteristic information, such as training visual characteristic information 514 is extracted by the video generation engine 606 using the plurality of training video frames. In an example, the training visual characteristic information 514 is extracted from the training video frames using image feature extraction techniques. It may be noted that other techniques may also be used to extract the training visual characteristic information 516 from the training video frames. The training visual characteristic information 514 further includes training attribute values for the plurality of training visual characteristics. Example of training visual characteristics include, but may not be limited to, color, tone, pixel value of each of the plurality of pixel, dimension, and orientation of the speaker's face based on the training video frames

Continuing with the present example, once the training audio characteristic information 512 and the training visual characteristic information 514 are extracted, the training engine 506 trains the video generation model 508 based on the training audio characteristic information 512 and the training visual characteristic 514. In an example, while training the video generation model 508, the training engine 506 classify each of the plurality of target visual characteristics comprised in the target visual characteristic information as one of a plurality of pre-defined visual characteristic categories based on the processing of the attribute values of the training audio characteristic information 512 and the training visual characteristic information 514.

Once classified, the training engine 106 assigns a weight for each of the plurality of target visual characteristics based on the training attribute values of the training audio characteristics 512 and the training visual characteristic information 514. In an example, the trained video generation model 508 includes an association between the training audio characteristic information 512 and training visual characteristic information 514. Such association may be used at the time inference to identify target visual characteristic information of a target video.

In another example, the video generation model 508 may be trained by the training engine 506 in such a manner that the video generation model 508 is made ‘overfit’ to predict a specific output video. For example, the video generation model 508 is trained by the training engine 506 based on the training audio characteristic information 512 and the training visual characteristic information 514. Once trained to be overfit, the video generation model 508 generates an output video which may be similar to the source video as it is without any change and having corresponding visual characteristic information.

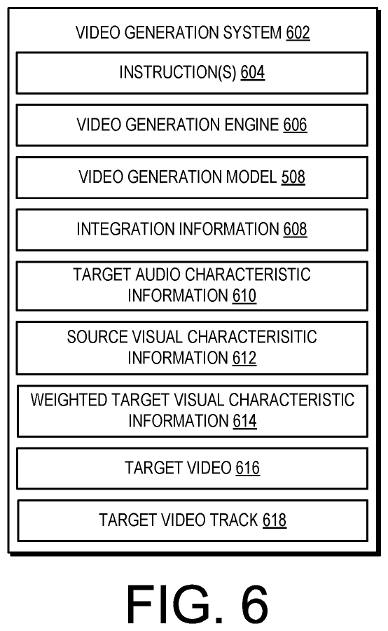

Returning to the present example, once the video generation model 508 is trained, it may be utilized for altering or modifying any source video track to a target video track. The manner in which the source video track is modified or altered to the target video track is further described in conjunction with FIG. 6.

FIG. 6 illustrates a block diagram of a video generation system 602 (referred to as system 602), for generating a target video track based on a source video track. In an example, the system 602 generates the target video track based on the source video track with specific portion of a plurality of video frames of the source video track altered and modified by processing audio characteristic information and visual characteristic information of the source video track. In one example, the system 602 may generate the target video track based on a trained video generation model, such as video generation model 508. To this end, the system obtains an integration information 608 including a plurality of source video frames accompanying a corresponding source audio data and source text data being spoken in each of the plurality of source video frames, a target text portion, and a target audio corresponding to the target text portion from a user through a computing device communicatively coupled with the system 602 to personalize specific portions of the source video track with a target video corresponding to the target text portion. Each of the plurality of source video frames comprises a source video data with a portion including lips of a speaker blacked out.

Similar to the system 502, the system 602 may further include instructions 604 and a video generation engine 606. In an example, the instructions 604 are fetched from a memory and executed by a processor included within the system 602. The video generation engine 606 may be implemented as a combination of hardware and programming, for example, programmable instructions to implement a variety of functionalities. In examples described herein, such combinations of hardware and programming may be implemented in several different ways. For example, the programming for the video generation engine 606 may be executable instructions, such as instructions 604.

Such instructions may be stored on a non-transitory machine-readable storage medium which may be coupled either directly with the system 602 or indirectly (for example, through networked means). In an example, the video generation engine 606 may include a processing resource, for example, either a single processor or a combination of multiple processors, to execute such instructions. In the present examples, the non-transitory machine-readable storage medium may store instructions, such as instructions 604, that when executed by the processing resource, implement video generation engine 606. In other examples, the video generation engine 606 may be implemented as electronic circuitry.

The system 602 may include a video generation model, such as the video generation model 508. The video generation model 508 is a multi-speaker video generation model which is trained based on a plurality of video tracks corresponding to a plurality of speakers to generate an output video corresponding to an input text with attribute values of the visual characteristics being selected from a plurality of visual characteristics of the plurality of speaker based on an input audio. In an example, the video generation model 508 may also be trained based on the source video track, source audio track, and source text data.

The system 602 may further include the integration information 608, a target audio characteristic information 610, a source visual characteristic information 612, a weighted target visual characteristic information 614, target video 616, and a target video track 618. As described above, the integration information 608 may include plurality of source video frames accompanying corresponding source audio data and source text data being spoken in each of the plurality of source video frames, the target text portion, and the target audio corresponding to the target text portion. The target audio characteristic information 610 is extracted from the target audio included in the integration information 608 which in turn further includes attribute values corresponding to a plurality of audio characteristics of the target audio. The source visual characteristic information 612 is extracted from the plurality of source video frames which in turn further includes source attribute values for a plurality of source visual characteristics.

In operation, initially, the system 602 may obtain an integration information 608 from the user who intends to alter or modify specific portions of source video track. The integration information 608 includes plurality of source video frames accompanying corresponding source audio data and source text data which is being spoken in each of the plurality of source video frames, target text portion, and the target audio. Thereafter, the video generation engine 606 of the system 602 process the target text portion and the target audio based on the trained video generation model 508 to extract a target audio characteristic information, such as the target audio characteristic information 610.

Amongst other things, the target audio characteristic information 610 may further include attribute values of the different audio characteristics. For example, the attribute values of the audio characteristics may specify the number of phonemes present (numerically), type of phonemes (alphanumerically), pitch of each phoneme (from −∞ to +∞), duration (in milli second) and energy (from −∞ to +∞) of each phoneme. Such phoneme level segmentation of source audio track and corresponding source text data provides accurate audio characteristics of a person for imitating. Example of audio characteristics includes, but may not be limited to, type of phoneme present in the reference voice sample, number of phonemes, duration of each phoneme, pitch of each phoneme, and energy of each phoneme.

Returning to the present example, the video generation engine 606 extracts a source visual characteristic information, such as source visual characteristic information 612 from the plurality of source video frames. In an example, the source visual characteristic information 612 may be obtained by the video generation engine 606 using image feature extraction technique. It may be noted that other techniques may also be used to extract the source visual characteristic information 612.

Once the target audio characteristic information 610 and the source visual characteristic information 612 are extracted, the video generation engine 606 process the target audio characteristic information 610 and the source visual characteristic information 612 based on the trained video generation model 508 to generate the target video corresponding to the target text portion. In an example, the video generation engine 606 process the target audio characteristic information 610 and the visual characteristic information 612 to assign a weight for each of a plurality of target visual characteristics comprised in a target visual characteristic information to generate a weighted target visual characteristics information, such as weighted target visual characteristic information 614.

Once the target visual characteristics are weighted suitably, the video generation engine 606 generate a target video, such as target video 616, comprising portion of the speaker's face visually interpreting movement of lips corresponding to the target text portion based on the weighted target visual characteristic information 614. For example, after assigning weight for each visual characteristic, the video generation engine 606 causes the video generation model 508 of the system 602 to use the assigned weight to generate target video 616.

Returning to the present example, once generated, the video generation engine 606 merge the target video 616 with an intermediate video to obtain the target video track 618 based on the source video track. In an example, the intermediate video includes source video track with video portion corresponding to the source text portion is blacked out to be replaced by the target video 616. The intermediate video may be generated by the video generation model 508 which is trained to be overfitted based on an intermediate text and corresponding intermediate audio and video data.

Similar to what has described in conjunction with description of FIG. 2, any model which is overfitted, is trained in such a manner that the model is may become closely aligned to a limited set of data which have been used while training. In such instances, the trained model, such as the video generation model 508, will not generalize the output, but would provide an output that is closely aligned to the input based on which the model may have been trained and thus become ‘overfitted’. In context with the present implementation, the video generation model 508 once overfitted, is used to generate an output video similar to that of the input video. For example, a user may intend to change a spoken portion present in the input video, corresponding to which the lip movement of a speaker's face vocalizing an input audio may also have to be changed. For example, the input video provided by a user may depict a speaker mouthing or depicting lip movement for an example sentence, such as “Hello Jack, please check out my product.”. The input video has to be changed such that the speaker may be depicted as mouthing or depicting lip movement corresponding to “Hello Dom, please check out my product”. In the current example, the video generation model 508 may be trained based on input corresponding to the input audio and input video with each of the plurality of video frames of the input video includes a video data with a portion including lips of the speaker blacked out. As may be understood, the video generation model 508 will thus, as a result of the training based on the example input video with lips portion blacked out and corresponding input audio will tend to become closely aligned or ‘overfitted’ based on the aforesaid input.

Once the video generation model 508 is trained based on the input video and corresponding input audio as described above, the resultant overfitted or further aligned video generation model 508 is used to generate an intermediate video with lips of the speaker moving in such a manner that it vocalize input audio which corresponds to “Hello ______, please check out my product” with the video portion corresponding to the word “Dom” is blacked out corresponding to the example input audio (as per the example depicted above) such that the intermediate video possesses similar visual characteristic information as that of the input video. Once the intermediate video is generated, the same may be merged with target video 616 to generate the target video track 618 which corresponds to “Hello Dom, please check out my product”. It may be noted that although the example has been explained in the context of the above example sentences, the same should not be construed to be a limitation. Furthermore, the overfitted video generation model 508 model may be trained on either the entire portion of the input audio or may be trained based on a portion or a combination of different portions of the input audio without deviating from the scope of the current subject matter.

In another example, the video generation engine 606 calculates a number of source video frames ‘M’ in which the source text portion is vocalized which is intended to be changed with video frames interpreting vocalization of target text portion. Further, the video generation engine 606 calculates a number of target video frames ‘N’ in which the target text portion is vocalized. Once M and N are calculated, if it is determined by the video generation engine 606 that M is equal to N, then the target video 616 is merged with the intermediate video to obtain the target video track 618. On the other hand, if M is not equal to N, the video generation engine 606 modify |M−N| number of video frames either by adding additional duplicate frames or by removing some video frames form the existing frames in the intermediate video to compensate for the difference in the video frames ‘M, N’ and then merge the target video 616 with the intermediate video to obtain the target video track 618.

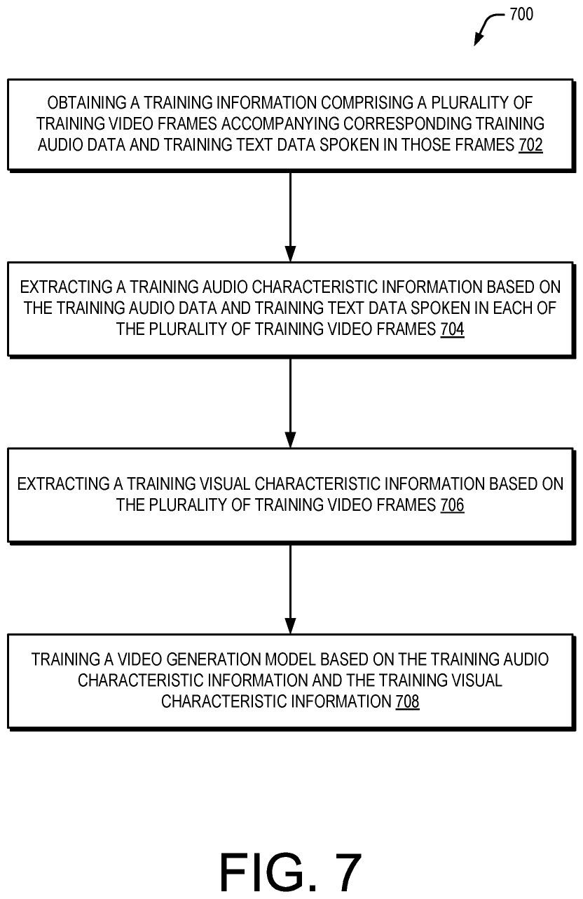

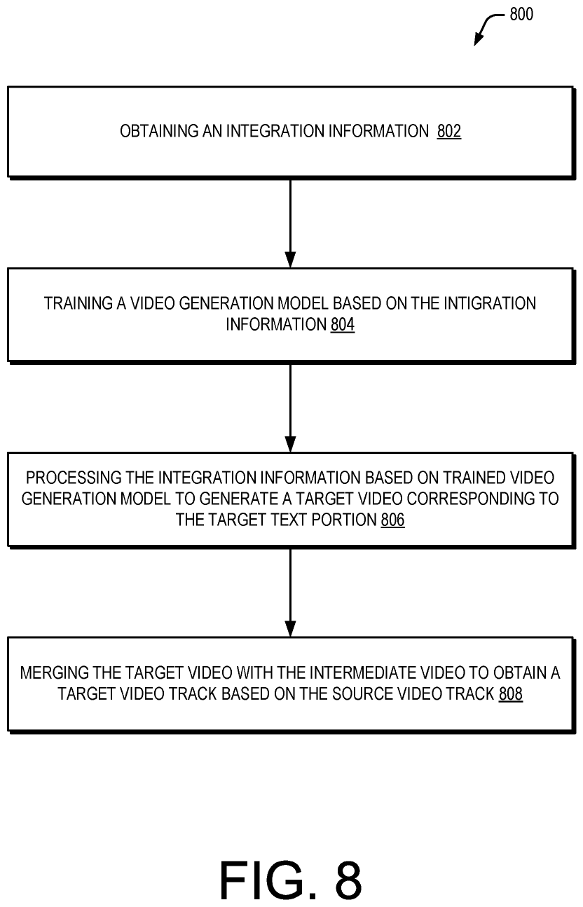

FIG. 7-8 illustrate example methods 700-800 for training a video generation model and generating a target video track based on a source video track with specific portions altered or modified, in accordance with examples of the present subject matter. The order in which the above-mentioned methods are described is not intended to be construed as a limitation, and some of the described method blocks may be combined in a different order to implement the methods, or alternative methods.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the methods may be performed by a training system, such as system 502 and a video generation system, such as system 602. In an implementation, the methods may be performed under an “as a service” delivery model, where the system 502 and the system 602, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 700 may be implemented by the system 502 for training the video generation model 508 based on a training information. At block 702, a training information is obtained. For example, the system 502 may obtain the training information 510 including a plurality of training video frames accompanying corre148sponding training audio data and training text data spoken in those frames for training the video generation model 508. Each of the plurality of training video frames comprises a training video data with a portion including lips of a speaker blacked out.

In one example, the training information 510 may be provided by a user operating through a computing device (not shown in FIG. 5) which may be communicatively coupled with the system 502. In an example, the user operating on the computing device may provide a source video track with a source audio track whose specific video portions are to be replaced with a target video including a portion of the speaker's face visually interpreting movement of lips corresponding to a target text portion. This same source video track may be used as training information 510 for training the video generation model 508. Further, the corresponding training audio data and the training text data to be used for training is generated by further processing the source video track.

In another example, the system 502 may be communicatively coupled to a sample data repository through a network (not shown in FIG. 5). In another example, the sample data repository may reside inside the system 502 as well. The sample data repository may further include training information including plurality of training video frames accompanying corresponding training audio data and training text data spoken in those frames.

At block 704, a training audio characteristic information is extracted from the training audio data and training text data spoken in each of the plurality of training video frames. For example, a training audio characteristic information, such as training audio characteristic information 512 is extracted by the video generation engine 606 using the training audio data and the training text data spoken in each of the plurality of training video frames. In an example, the training audio characteristic information 512 is extracted from the training audio data using phoneme level segmentation of training text data. The training audio characteristic information 512 further includes plurality of training attribute values for the plurality of training audio characteristics. Examples of training audio characteristics include, but may not be limited to, type of phonemes present in the training audio data, number of phonemes, duration of each phoneme, pitch of each phoneme, and energy of each phoneme.

At block 706, a training visual characteristic information is extracted from the plurality of training video frames. For example, training visual characteristic information 514 is extracted by the video generation engine 606 using the plurality of training video frames. In an example, the training visual characteristic information 514 is extracted from the training video frames using image feature extraction techniques. It may be noted that other techniques may also be used to extract the training visual characteristic information 516 from the training video frames. The training visual characteristic information 514 further includes training attribute values for the plurality of training visual characteristics. Example of training visual characteristics include, but may not be limited to, color, tone, pixel value of each of the plurality of pixel, dimension, and orientation of the speaker's face based on the training video frames.

At block 708, a video generation model is trained based on the training audio characteristic information and training visual characteristic information. For example, the training engine 506 trains the video generation model 508 based on the training audio characteristic information 512 and the training visual characteristic 514. In an example, while training the video generation model 508, the training engine 506 classify each of the plurality of target visual characteristics comprised in the target visual characteristic information as one of a plurality of pre-defined visual characteristic categories based on the processing of the attribute values of the training audio characteristic information 512 and the training visual characteristic information 514.

Once classified, the training engine 106 assigns a weight for each of the plurality of target visual characteristics based on the training attribute values of the training audio characteristics 512 and the training visual characteristic information 514. In an example, the trained video generation model 508 includes an association between the training audio characteristic information 512 and training visual characteristic information 514. Such association may be used at the time inference to identify target visual characteristic information of a target video.

In another example, the video generation model 508 may be trained by the training engine 506 in such a manner that the video generation model 508 is made ‘overfit’ to predict a specific output video. For example, the video generation model 508 is trained by the training engine 506 based on the training audio characteristic information 512 and the training visual characteristic information 514. Once trained to be overfit, the video generation model 508 generates an output video which may be similar to the source video as it is without any change and having corresponding visual characteristic information.

Returning to the present example, once the video generation model 508 is trained, it may be utilized for altering or modifying any source video track to a target video track.

FIG. 8 illustrates an example method 800 for generating a target video track based on a source video track using the trained video generation model 508, in accordance with examples of the present subject matter. The order in which the above-mentioned method is described is not intended to be construed as a limitation, and some of the described method blocks may be combined in a different order to implement the methods, or alternative methods.

For example, the methods may be performed by a training system, such as system 502 and a video generation system, such as system 602. In an implementation, the methods may be performed under an “as a service” delivery model, where the system 502 and the system 602, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 802, an integration information including a plurality of source video frames accompanying a corresponding source audio data and source text data being spoken in each of the plurality of source video frames, a target text portion, and a target audio corresponding to the target text portion. For example, the system 602 may obtain an integration information 608 from the user who intends to alter or modify specific portions of source video track. The integration information 608 includes plurality of source video frames accompanying corresponding source audio data and source text data which is being spoken in each of the plurality of source video frames, target text portion, and the target audio.

At block 804, the plurality of source video frames accompanying corresponding source audio data and source text data spoken in those frames included in the integration information is used for training a video generation model. For example, the training engine 506 of the system 502 trains the video generation model 508 based on the plurality of source video frames accompanying corresponding source audio data and source text data spoken in those frames as per the method steps as described in conjunction with FIG. 7.

At block 806, the integration information is processed based on the trained video generation model to generate a target video corresponding to the target text portion. For example, the video generation engine 606 of the system 602 process the target text portion and the target audio based on the trained video generation model 508 to extract a target audio characteristic information, such as the target audio characteristic information 610.

Amongst other things, the target audio characteristic information 610 may further include attribute values of the different audio characteristics. For example, the attribute values of the audio characteristics may specify the number of phonemes present (numerically), type of phonemes (alphanumerically), pitch of each phoneme (from −∞ to +∞), duration (in milli second) and energy (from −∞ to +∞) of each phoneme. Such phoneme level segmentation of source audio track and corresponding source text data provides accurate audio characteristics of a person for imitating. Example of audio characteristics includes, but may not be limited to, type of phoneme present in the reference voice sample, number of phonemes, duration of each phoneme, pitch of each phoneme, and energy of each phoneme.

Returning to the present example, the video generation engine 606 extracts a source visual characteristic information, such as source visual characteristic information 612 from the plurality of source video frames. In an example, the source visual characteristic information 612 may be obtained by the video generation engine 606 using image feature extraction technique. It may be noted that other techniques may also be used to extract the source visual characteristic information 612.

Once the target audio characteristic information 610 and the source visual characteristic information 612 are extracted, the video generation engine 606 process the target audio characteristic information 610 and the source visual characteristic information 612 based on the trained video generation model 508 to generate the target video corresponding to the target text portion. In an example, the video generation engine 606 process the target audio characteristic information 610 and the visual characteristic information 612 to assign a weight for each of a plurality of target visual characteristics comprised in a target visual characteristic information to generate a weighted target visual characteristics information, such as weighted target visual characteristic information 614.

Once the target visual characteristics are weighted suitably, the video generation engine 606 generate a target video, such as target video 616, comprising portion of the speaker's face visually interpreting movement of lips corresponding to the target text portion based on the weighted target visual characteristic information 614. For example, after assigning weight for each visual characteristic, the video generation engine 606 causes the video generation model 508 of the system 602 to use the assigned weight to generate target video 616.

At block 808, the target video is merged with an intermediate video to obtain a target video track based on the source video track. For example, the video generation engine 606 merge the target video 616 with an intermediate video to obtain the target video track 618 based on the source video track. In an example, the intermediate video includes source video track with video portion corresponding to the source text portion is blacked out to be replaced by the target video 616. The intermediate video may be generated by the video generation model 508 which is trained to be overfitted based on an intermediate text and corresponding intermediate audio and video data.

For example, a user may intend to change in the input video the lip movement of a speaker's face vocalizing an input audio, such as “Hello Jack, please check out my product” to “Hello Dom, please check out my product”. In the current example, the video generation model 508 may be trained based on input corresponding to the input audio and input video with each of the plurality of video frames of the input video includes a video data with a portion including lips of the speaker blacked out. As may be understood, the video generation model 508 will thus, as a result of the training based on the example input video with lips portion blacked out and corresponding input audio will tend to become closely aligned or ‘overfitted’ based on the aforesaid input.

Once the video generation model 508 is trained based on the input video and corresponding input audio as described above, the resultant overfitted or further aligned video generation model 508 is used to generate an intermediate video with lips of the speaker moving in such a manner that it vocalize input audio which corresponds to “Hello ______, please check out my product” with the video portion corresponding to the word “Dom” is blacked out corresponding to the example input audio (as per the example depicted above) such that the intermediate video possesses similar visual characteristic information as that of the input video. Once the intermediate video is generated, the same may be merged with target video 616 to generate the target video track 618 which corresponds to “Hello Dom, please check out my product”. It may be noted that although the example has been explained in the context of the above example sentences, the same should not be construed to be a limitation. Furthermore, the overfitted video generation model 508 model may be trained on either the entire portion of the input audio or may be trained based on a portion or a combination of different portions of the input audio without deviating from the scope of the current subject matter.

In another example, the video generation engine 606 calculates a number of source video frames ‘M’ in which the source text portion is vocalized which is intended to be changed with video frames interpreting vocalization of target text portion. Further, the video generation engine 606 calculates a number of target video frames ‘N’ in which the target text portion is vocalized. Once M and N are calculated, if it is determined by the video generation engine 606 that M is equal to N, then the target video 616 is merged with the intermediate video to obtain the target video track 618. On the other hand, if M is not equal to N, the video generation engine 606 modify |M−N| number of video frames either by adding additional duplicate frames or by removing some video frames form the existing frames in the intermediate video to compensate for the difference in the video frames ‘M, N’ and then merge the target video 616 with the intermediate video to obtain the target video track 618.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
an audio generation engine coupled to the processor, wherein the audio generation engine is configured to:
obtain an integration information comprising a source audio track, a source text portion, and a target text portion, wherein the target text portion provides for a text to be converted to spoken audio;
process the target text portion based on an audio generation model to generate a target audio corresponding to the target text portion, wherein the audio generation model is trained based on the source audio track and a source text data; and
merge the target audio with an intermediate audio to obtain a target audio track based on the source audio track, wherein the intermediate audio comprises source audio track with audio portion corresponding to the source text portion to be replaced by the target audio.

2. The system as claimed in claim 1, wherein the audio generation model is a multi-speaker audio generation model which is trained based on a plurality of audio tracks corresponding to a plurality of speakers to generate an output audio corresponding to an input text with attribute values of audio characteristics being selected from a plurality of visual characteristics of the plurality of speaker based on an input audio.

3. The system as claimed in claim 1, wherein to process the target text portion based on the audio generation model, the audio generation engine is configured to:
extract an audio characteristic information of the source audio track based on phoneme level segmentation of a source text, wherein the audio characteristic information comprises attribute values for a plurality of audio characteristics;
process the audio characteristic information based on the audio generation model to assign a weight for each of the plurality of audio characteristics to generate a weighted audio characteristics information; and
based on the weighted audio characteristic information, generate the target audio corresponding to the target text portion.

4. The system as claimed in claim 3, wherein the plurality of audio characteristics comprises number of phonemes, a type of each phoneme present in the source audio track, duration of each phoneme, pitch of each phoneme, and energy of each phoneme.

5. The system as claimed in claim 1, wherein to process the target text portion based on the audio generation model, the audio generation engine is to:
compare the target text portion with a training text portion dataset, wherein the audio generation model is trained based on the training text portion dataset;
based on the comparison, extract a predefined duration of each phoneme present in the target text portion which is linked with audio characteristic information of the training text portion dataset with other audio characteristic information are selected based on the source audio track; and
generate the target audio corresponding to the target text portion based on the extracted predefined duration of each phoneme and audio characteristic information selected based on the source audio track.

6. The system as claimed in claim 1, wherein the audio generation engine is configured to:
generate the intermediate audio corresponding to an intermediate text using the audio generation model which is trained based on audio characteristic information to make it overfit, wherein the audio generation model, when overfitted, is to predict the intermediate audio corresponding to the intermediate text based on the audio characteristic information extracted from the source audio.

7. The system as claimed in claim 6, wherein the intermediate text comprises source text data with text portion corresponding to the source text portion to be replaced by the target text portion.

8. A method comprising:
obtaining a training information comprising a training audio track and a training text data;
extracting a training audio characteristic information from the training audio track using phoneme level segmentation of training text data, wherein the training audio characteristic information comprises training attribute values for a plurality of training audio characteristics; and
training an audio generation model based on the training audio characteristic information, wherein the audio generation model, when trained is to generate a target audio corresponding to a target text portion based on the training audio characteristic information of the training audio track.

9. The method as claimed in claim 8, wherein the training an audio generation model based on the training audio characteristic information comprises:
classifying each of the plurality of training audio characteristics as one of a plurality of pre-defined audio characteristic categories based on the type of the training audio characteristics; and
assigning a weight for each of the plurality of training audio characteristics based on the training attribute values of the training audio characteristics.

10. The method as claimed in claim 8, wherein the audio generation model is a multi-speaker audio generation model which is pre-trained based on a plurality of audio tracks of a plurality of speakers to generate an output audio corresponding to an input text with vocal characteristics of one of a speaker selected from a plurality of vocal characteristics of a plurality of speakers based on an input audio.

11. The method as claimed in claim 8, wherein the training audio characteristics comprising a type of phonemes present in a source audio track, number of phonemes, duration of each phonemes, pitch of each phonemes, and energy of each phonemes.

12. The method as claimed in claim 8, wherein while training, on determining that the type of the training audio characteristic does not correspond to any of a pre-defined audio characteristic category, creating a new category of audio characteristic and assigning a new weight to the training audio characteristic.

13. The method as claimed in claim 8, wherein while training, on determining that the type of the training audio characteristic corresponds to any of a pre-defined audio characteristic category and the value of the training attribute value corresponds to a pre-defined weight of the attribute value, assigning the pre-defined weight of the attribute value to the training audio characteristic.

14. The method as claimed in claim 8, wherein the method comprises:
training the audio generation model based on the training audio characteristic information using phoneme level segmentation of training text data to make it overfit, wherein when overfitted, the audio generation model is to predict an intermediate audio corresponding to intermediate text based on the audio characteristic information extracted from the training audio track.

15. A system comprising:
a processor;
a video generation engine coupled to the processor, wherein the video generation engine is configured to:
obtain an integration information comprising a plurality of source video frames accompanying a corresponding source audio data and source text data being spoken in each of the plurality of source video frames, a target text portion, and a target audio corresponding to the target text portion;
process the target text portion and the target audio based on a video generation model to generate a target video comprising a portion of a speaker's face visually interpreting movement of lips corresponding to the target text portion, wherein the video generation model is trained based on a source video track information; and
merge the target video with an intermediate video to obtain a target video track based on the source video track, wherein the intermediate video comprises source video track with video portion corresponding to the source text data is blacked out to be replaced by the target video.

16. The system as claimed in claim 15, wherein the video generation model is a multi-speaker video generation model which is trained based on a number of video tracks to generate an output video indicating the portion of the speaker's face visually interpreting movement of lips corresponding to an input text with values of visual characteristics being selected from a plurality of visual characteristics of a plurality of speaker based on an input audio.

17. The system as claimed in claim 15, wherein to process the target text portion and the target audio based on the video generation model, the video generation engine is configured to:
extract a target audio characteristic information from the target audio based on phoneme level segmentation of the target text portion, wherein the target audio characteristic information comprises attribute values for a plurality of audio characteristics;
extract a source visual characteristic information from the plurality of source video frames, wherein the source visual characteristic information comprises source attribute values for a plurality of source visual characteristics;
process the target audio characteristic information and the source visual characteristic information based on the video generation model to assign a weight for each of a plurality of target visual characteristics comprised in a target visual characteristic information to generate a weighted target visual characteristics information; and
based on the weighted target visual characteristic information, generate the target video corresponding to the target text portion.

18. The system as claimed in claim 17, wherein the plurality of audio characteristics comprises number of phonemes, a type of each phoneme present in the source audio track, duration of each phoneme, pitch of each phoneme, and energy of each phoneme.

19. The system as claimed in claim 17, wherein the source visual characteristics comprises color, tone, pixel value of each of a plurality of pixel, dimension, and orientation of the speaker's face based on the source video frames and the target visual characteristics comprising color, tone, pixel value of each of the plurality of pixel, dimension, and orientation of the lips of the speaker.

20. The system as claimed in claim 15, wherein the video generation engine is configured to:
generate the intermediate video corresponding to an intermediate audio and an intermediate text using the video generation model, wherein the video generation model is trained based on visual characteristic information and audio characteristic information extracted from a source video and a source audio to make it overfit, wherein the video generation model, when overfitted, is to predict the intermediate video corresponding to the intermediate text based on the audio characteristic information and visual characteristic information extracted from the source video and source audio.

21. The system as claimed in claim 15, wherein to process the target text portion based on the video generation model, the video generation engine is configured to:
calculate a number of source video frames, M, in which a source text portion is vocalized based on the source video;
calculate a number of target video frames, N, in which the target text portion is vocalized based on the target video;
if M=N, merge the target video with the intermediate video to obtain the target video track; or
if M is not equal to N, modify |M−N| number of video frames to compensate for the difference in the video frames in the intermediate video and then merge the target video with the intermediate video to obtain the target video track.

22. A method comprising:
obtaining a training information comprising a plurality of training video frames accompanying corresponding training audio data and training text data spoken in those frames, wherein each of the plurality of training video frames comprises a training video data with a portion comprising lips of a speaker blacked out;
extracting a training audio characteristic information based on the training audio data and training text data spoken in each of the plurality of training video frames, wherein the training audio characteristic information comprises training attribute values for a plurality of training audio characteristics;
extracting a training visual characteristic information using the plurality of training video frames, wherein the training visual characteristic information comprises training attribute values for a plurality of training visual characteristics; and
training a video generation model based on the training audio characteristic information and the training visual characteristic information, wherein the video generation model, when trained is to generate a target video having a target visual characteristic information corresponding to a target text portion based on a target audio characteristic information of a target audio data.

23. The method as claimed in claim 22, wherein the training a video generation model based on the training audio characteristic information comprises:
classifying each of a plurality of target visual characteristics comprised in the target visual characteristic information as one of a plurality of pre-defined visual characteristic categories based on the training audio characteristic information and the training visual characteristic information; and
assign a weight for each of the plurality of visual characteristics based on the training attribute values of the training audio characteristics and the training visual characteristics.

24. The method as claimed in claim 22, wherein the video generation model is a multi-speaker video generation model which is trained based on a number of video tracks to generate an output video indicating the portion of the speaker's face visually interpreting movement of lips corresponding to an input text with values of visual characteristics being selected from a plurality of visual characteristics of a plurality of speaker based on an input audio.

25. The method as claimed in claim 23, wherein the plurality of training audio characteristics comprises one of number of phonemes, a type of each phoneme present in a source audio track, duration of each phoneme, pitch of each phoneme, energy of each phoneme, and combination thereof.

26. The method as claimed in claim 24, wherein the training visual characteristics comprises color, tone, pixel value of each of a plurality of pixels, dimension, orientation, of the speaker's face based on the training video frames and the target visual characteristics comprising color, tone, pixel value of each of the plurality of pixels, dimension, and orientation of the lips of the speaker.

27. The method as claimed in claim 22, wherein the method comprises:
training the video generation model based on the training audio characteristic information and training visual characteristic information to make it overfit, wherein when overfitted, the video generation model is to predict the intermediate video corresponding to an intermediate text and an intermediate audio based on the training audio characteristic information and training visual characteristic information extracted from the training information.

28. A non-transitory computer-readable medium comprising instructions, the instructions being executable by a processing resource cause the processing resource to:
obtain an audio integration information comprising a source audio track, a source text portion, and a target text portion, wherein the target text portion provides for a text to be converted to spoken audio;
process the target text portion based on an audio generation model to generate a target audio corresponding to the target text portion, wherein the audio generation model is trained based on the source audio track and a source text data;
merge the target audio with an intermediate audio to obtain a target audio track based on the source audio track, wherein the intermediate audio comprises source audio track with audio portion corresponding to the source text portion to be replaced by the target audio is removed;
obtain a video integration information comprising a plurality of source video frames accompanying a corresponding source audio and source text data being spoken in each of the plurality of source video frames, a target text portion, and a target audio corresponding to the target text portion;
process the target text portion and the target audio based on a video generation model to generate a target video comprising a portion of a speaker's face visually interpreting movement of lips corresponding to the target text portion, wherein the video generation model is trained based on a source video track information;
merge the target video with an intermediate video to obtain a target video track based on the source video track, wherein the intermediate video comprises source video track with video portion corresponding to the source text portion is blacked out to be replaced by the target video; and
associate the target audio track with the target video track to obtain a target audio-visual track.

29. The non-transitory computer-readable medium as claimed in claim 28, wherein the audio generation model is a multi-speaker audio generation model which is trained based on a plurality of audio tracks corresponding to a plurality of speakers to generate an output audio corresponding to an input text with attribute values of audio characteristics being selected from a plurality of visual characteristics of the plurality of speaker based on an input audio.

30. The non-transitory computer-readable medium as claimed in claim 28, wherein the video generation model is a multi-speaker video generation model which is trained based on a number of video tracks to generate an output video indicating the portion of the speaker's face visually interpreting movement of lips corresponding to an input text with values of visual characteristics being selected from a plurality of visual characteristics of a plurality of speaker based on an input audio.

31. The non-transitory computer-readable medium as claimed in claim 28, wherein to process the target text portion based on the audio generation model, the processing resource is configured to:
extract an audio characteristic information of the source audio track based on phoneme level segmentation of a source text, wherein the audio characteristic information comprises attribute values for a plurality of audio characteristics;
process the audio characteristic information based on the audio generation model to assign a weight for each of the plurality of audio characteristics to generate a weighted audio characteristics information; and
based on the weighted audio characteristic information, generate the target audio corresponding to the target text portion.

32. The non-transitory computer-readable medium as claimed in claim 29, wherein to process the target text portion and the target audio based on the video generation model, the processing resource is configured to:
extract a target audio characteristic information from the target audio based on phoneme level segmentation of the target text portion, wherein the target audio characteristic information comprises attribute values for a plurality of audio characteristics;
extract a source visual characteristic information from the plurality of source video frames, wherein the source visual characteristic information comprises source attribute values for a plurality of source visual characteristics;
process the target audio characteristic information and the source visual characteristic information based on the video generation model to assign a weight for each of a plurality of target visual characteristics comprised in a target visual characteristic information to generate a weighted target visual characteristics information; and
based on the weighted target visual characteristic information, generate the target video corresponding to the target text portion.

33. The non-transitory computer-readable medium as claimed in claim 31, wherein the plurality of audio characteristics comprises number of phonemes, a type of each phoneme present in the source audio track, duration of each phoneme, pitch of each phoneme, and energy of each phoneme.

34. The non-transitory computer-readable medium as claimed in claim 32, wherein the source visual characteristics comprises color, tone, pixel value of each of a plurality of pixel, dimension, and orientation of the speaker's face based on the source video frames and the target visual characteristics comprising color, tone, pixel value of each of the plurality of pixel, dimension, and orientation of the lips of the speaker.
